(19) United States
(12) Patent Application Publication
(10) Pub. No.: US 2025/0175964 A1
(43) Pub. Date: May 29, 2025

(54) CO-PHASING BEAMS

(71) Applicant: Nokia Technologies Oy, Espoo (FI)

(72) Inventors: Rana AHMED, Stuttgart (DE); Filippo TOSATO, Massy (FR); Rafael CAUDURO DIAS DE PAIVA, Aalborg (DK); Eugene VISOTSKY, Naperville, IL (US); Keeth Saliya Jayasinghe LADDU, Espoo (FI)

(21) Appl. No.: 18/839,827

(22) PCT Filed: Mar. 29, 2023
(86) PCT No.: PCT/IB2023/053122

§ 371 Date: Aug. 20, 2024

(30) Foreign Application Priority Data
Apr. 11, 2022 (FI) 20225314

(51) Int. Cl. H04W 72/044; H04B 7/06; H04B 17/309

(52) U.S. Cl. CPC H04W 72/046; H04B 7/0617; H04B 7/06952; H04B 17/309

(57) ABSTRACT

An apparatus may be configured with configuration information for beam measurements for a set of first beams, and then receive second configuration information with an indication to co-phase two or more first beams to one or more second beams. Responsive to the indication, the apparatus co-phases. per a second beam, corresponding two or more first beams to the second beam.

### TECHNICAL FIELD

Various example embodiments relate to wireless communications.

### BACKGROUND

Wireless communication systems are under constant development, including enhancement to existing features, for example multiple-input multiple-output enhancements, beamforming enhancements and different intra-cell and intercell scenarios.

### BRIEF DESCRIPTION

The subject matter of the independent claims defines the scope.

According to an aspect there is provided a first apparatus comprising at least one processor; and at least one memory including computer program code, the at least one memory and computer program code being configured to, with the at least one processor, cause the first apparatus to perform: receiving, from a second apparatus controlling an operation of a serving cell, first configuration information for beam measurements for a set of first beams; receiving, from the second apparatus, second configuration information with an indication to co-phase two or more first beams to one or more second beams; and co-phasing, per a second beam, corresponding two or more first beams to the second beam.

In embodiments, the first beams and the one or more second beams are P port beams, wherein P is a positive integer.

In embodiments, the at least one memory and computer program code are configured to, with the at least one processor, further cause the first apparatus to perform, per the second beam, the co-phasing by summing the two or more first beams or by applying a corresponding co-phasing codebook.

In embodiments, the at least one memory and computer program code are configured to, with the at least one processor, further cause the first apparatus to perform: receiving, from the second apparatus, in the first configuration information, a mobility detection configuration, the mobility detection configuration comprising a criterion for detecting a high mobility state of the first apparatus; determining a measurement of the first beams according to the first configuration information; sending, in response to the criterion being satisfied, to the second apparatus an indication of the high mobility state; and receiving the second configuration information as a response to the indication.

In embodiments, the mobility detection configuration comprises at least a mobility threshold as the criterion, and wherein the at least one memory and computer program code are configured to, with the at least one processor, further cause the first apparatus to perform: determining, based at least on beam measurement results of the first beams, a first value; and determining that the criterion is satisfied at least when the first value exceeds the mobility threshold.

In embodiments, the mobility detection configuration further comprises a mobility detection timer, and wherein the at least one memory and computer program code are configured to, with the at least one processor, further cause the first apparatus to perform: starting the mobility detection timer; determining, at a starting time of the mobility detection timer, a second value based on corresponding measurement results of the first beams; determining, at a time the mobility detection timer expires, a third value based on corresponding measurement results of the first beams; and determining the first value by determining a variation between the second value and the third value.

In embodiments, the first value is a channel estimation variation, or a timing offset variation or a Doppler frequency estimation.

In embodiments, a first beam is associated to a channel state information reference signal resource or to a synchronization signal block resource of a resource set and the second beam is associated with a group of channel state information reference signal resources or to a group of synchronization signal block resources within the resource set.

In embodiments, wherein the at least one memory and computer program code are configured to, with the at least one processor, further cause the first apparatus to perform: determining measurements of both the first beams and the second beams; determining a best beam amongst the first beams and the second beams; and reporting to the second apparatus the best beam by indicating a beam index of the best beam.

According to an aspect there is provided a second apparatus comprising at least one processor; and at least one memory including computer program code, the at least one memory and computer program code being configured to, with the at least one processor, cause the second apparatus to perform: controlling the operation of a cell serving a first apparatus; transmitting, to the first apparatus, first configuration information for beam measurements for a set of first beams; and transmitting to the first apparatus second configuration information with an indication to co-phase two or more first beams to one or more second beams.

In embodiments, the at least one memory and computer program code are configured to, with the at least one processor, further cause the second apparatus to: determining a high mobility state of the first apparatus responsive to receiving from the first apparatus an indication of the high mobility state; and transmitting the second configuration information in response to the high mobility state.

In embodiments, the at least one memory and computer program code are configured to, with the at least one processor, further cause the second apparatus to: determining a measurement of reference signals transmitted by the first apparatus; determining, based at least on measurement results, a first value; determining a high mobility state of the first apparatus responsive to the first value exceeding a mobility threshold; and transmitting the second configuration information in response to the high mobility state.

In embodiments, the at least one memory and computer program code are configured to, with the at least one processor, further cause the second apparatus to perform: starting a mobility detection timer; determining, at a starting time of the mobility detection timer, a second value based on corresponding measurement results of the reference signals; determining, at a time the mobility detection timer expires, a third value based on corresponding measurement results of the reference signals; and determining the first value by determining a variation between the second value and the third value.

In embodiments, the first value is a channel estimation variation, or a timing offset variation or a Doppler frequency estimation.

According to an aspect there is provided a method comprising: receiving, by a first apparatus, from a second apparatus controlling an operation of a serving cell, first configuration information for beam measurements for a set of first beams; receiving, by the first apparatus, from the second apparatus, second configuration information with an indication to co-phase two or more first beams to one or more second beams; and co-phasing, per a second beam, corresponding two or more first beams to the second beam.

According to an aspect there is provided a method comprising: controlling, by a second apparatus, the operation of a cell serving a first apparatus; transmitting, by the second apparatus, to the first apparatus, first configuration information for beam measurements for a set of first beams; and transmitting, by the second apparatus, to the first apparatus, second configuration information with an indication to co-phase two or more first beams to one or more second beams.

### BRIEF DESCRIPTION OF DRAWINGS

Embodiments are described below, by way of example only, with reference to the accompanying drawings, in which

FIGS. 1 and 2 illustrate exemplified wireless communication systems;

FIGS. 3 to 7 are flow charts illustrating examples of functionalities;

FIGS. 8 and 9 illustrate exemplified information exchange;

FIGS. 10 and 11 are flow charts illustrating examples of functionalities; and

FIGS. 12 and 13 are schematic block diagrams.

### DETAILED DESCRIPTION OF SOME EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the structural elements are not restricted by the terms. The terms are used merely for the purpose of distinguishing an element from other elements. For example, a first beam could be termed a second beam, and similarly, a second beam could be also termed a first beam without departing from the scope of the present disclosure.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultrawideband (UWB) technology, sensor networks, mobile ad-hoc networks (MANETs) and Internet Protocol multimedia subsystems (IMS) or any combination thereof.

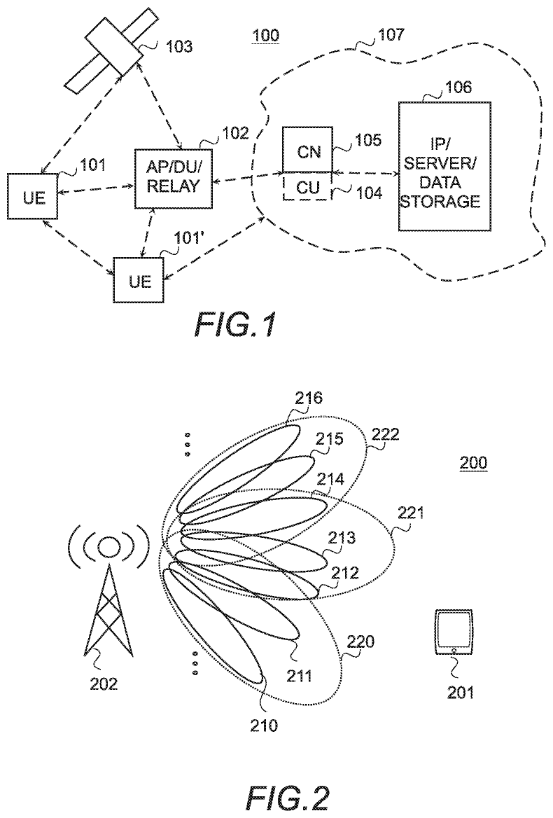

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system 100 given as an example but a person skilled in the art may apply the solution to other communication systems provided with necessary properties.

The example of FIG. 1 shows a part of an exemplifying radio access network.

FIG. 1 shows user devices 101, 101′ configured to be in a wireless connection on one or more communication channels with a node 102. The node 102 is further connected to a core network 105. In one example, the node 102 may be an access node such as (e/g) NodeB providing or serving devices in a cell. In one example, the node 102 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 105 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), or access and mobility management function (AMF), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The user device may also utilise cloud. In some applications, a user device may comprise a user portable device with radio parts (such as a watch, earphones, eyeglasses, other wearable accessories or wearables) and the computation is carried out in the cloud. The device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyberphysical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 106, or utilise services provided by them. The communication network may also be able to support the usage of cloud services, for example at least part of core network operations may be carried out as a cloud service (this is depicted in FIG. 1 by “cloud” 107). The communication system may also comprise a central control entity, or a like, providing facilities for networks of different operators to cooperate for example in spectrum sharing.

The technology of Edge cloud may be brought into a radio access network (RAN) by utilizing network function virtualization (NVF) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 102) and non-real time functions being carried out in a centralized manner (in a centralized unit, CU 104).

It should also be understood that the distribution of labour between core network operations and base station operations may differ from that of the LTE or even be non-existent Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite 103 in the mega-constellation may cover several satellite-enabled network entities that create on-ground cells. The on-ground cells may be created through an on-ground relay node 102 or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto-or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) nodeBs), a home node B gateway, or HNB-GW (not shown in FIG. 1). A HNB Gateway (HNB-GW), which is typically installed within an operator's network may aggregate traffic from a large number of HNBs back to a core network.

It is envisaged that in 5G, 6G and beyond, larger and larger antenna arrays and enhanced beam management will be used for improving reliability, coverage, and capacity performance through flexible deployment scenarios. For example, to support mobility for beam measuring and beam reporting with a single access node, for example, a device may be configured to co-phase beams. The co-phasing configuration may be seen as a configuration to measure, and possibly report, a group of beams as one synthetic beam. Different examples are described below using principles and terminology of 5G technology without limiting the examples to 5G, and the terminology used.

FIG. 2 illustrates a zoom view of a radio access system 200 illustrated in FIG. 1.

Referring to FIG. 2, in the illustrated example the radio access network 200 provides wireless interface (wireless access) to first apparatuses, depicted in FIG. 2 by a user device 201 by means of one or more second apparatuses 202.

A second apparatus 202 may be an apparatus, for example a base station or corresponding access node, that is configured to control operation of one or more cells provided by said apparatus, and/or configured to control operation of one or more cells provided by one or more other apparatuses, for example transmission-reception points. A transmission-reception point may be a base station or another access node, or an operational entity comprising one or more antennas in a base station, or an operational entity comprising one or more remote radio heads, or a remote antenna of a base station, or any other set of geographically co-located antennas forming one operational entity, for example an antenna array with one or more antenna elements, for one cell in the radio access network 200, or for a part of the one cell. The operational entity may be configured to transmit and receive data and different reference signals over a plurality of beams 210, 211, 212, 213, 214, 215, 216, said beams being called herein first beams. A first beam may have its own index value, that may be used in reporting to identify the first beam. The index value may be a channel state information reference signal resource index, CRI, value or a synchronized signal block resource index, SSBRI, value.

A first apparatus 201 may be a user device, for example a user equipment or a vehicle, or comprised in another apparatus, or comprising a further apparatus, further examples being given above with FIG. 1. The first apparatus 201 may be configured at least to determine beam measurements for a set of beams 210, 211, 212, 213, 214, 215, 216 of the plurality of beams. The first apparatus 201 may be configured, as will be described in more detail below, to co-phase the beams (first beams) in the set of beams to second beams 220, 221, 222. A co-phased beam, i.e. a second beam, corresponds to two or more first beams or comprises two or more first beams, and it may be called a synthesized beam. Since the second beam is formed by co-phasing two or more first beams, the second beam is wider than a first beam. Further, the second beam may have its own index value, for example a group index value, that may be used in reporting to identify the second beam. Further, during co-phasing, the first apparatus may be configured to associate, per the second beam, the second beam with the co-phased first beams, using for example index values.

A beam represents a resource, for example a channel state information reference signal, CSI-RS, resource, or a synchronization signal block, SSB, resource. The co-phased resources, or a second beam, may be called a resource group. In other words, a first beam may be associated to a channel state information reference signal resource or to a synchronization signal block resource of a resource set and the second beam may be associated with a group of channel state information reference signal resources of the resource set or with a group of synchronization signal block resources of the resource set. In other words, a resource set may be partitioned in multiple resource group sets (resource groups) having different sizes.

For example, a set of N first beams may comprise, as one resource group set, N first beams, possibly as a second resource group set M second beams, wherein a second beam comprises A first beams, and/or possibly as a third resource group set L second beams, wherein a second beam comprises B first beams, or second beams may comprise different number of first beams.

A first beam may be configured with a transmission configuration indicator (TCI) state, which associates the beam with one or two other downlink reference signals and a corresponding quasi-colocation (QCL) type. For example, if two first beams have different QCL-type D sources, the first apparatus may use different receive filters to correctly receive the two beams. For each synthetized beam, the TCI-state may be explicitly configured by the second apparatus or may be implicitly derived by the first apparatus from the TCI-states of the first beams in the resource group associated to the synthesized beam.

For example, the second apparatus may have configured the first apparatus with a set of 64 first beams, the first beams having 2 ports. Then the second apparatus may configure the first apparatus to co-phase the set of beams by cophasing 8 first beams together, resulting to 8 second beams having 2 ports. The second apparatus may configure the first apparatus to co-phase the first beams in an overlapping manner, resulting for example in 9 or more second beams. Still further alternatives include that the first apparatus may be configured to co-phase first beams having a common quasi co-location, QCL, source. Further possibilities will be given below.

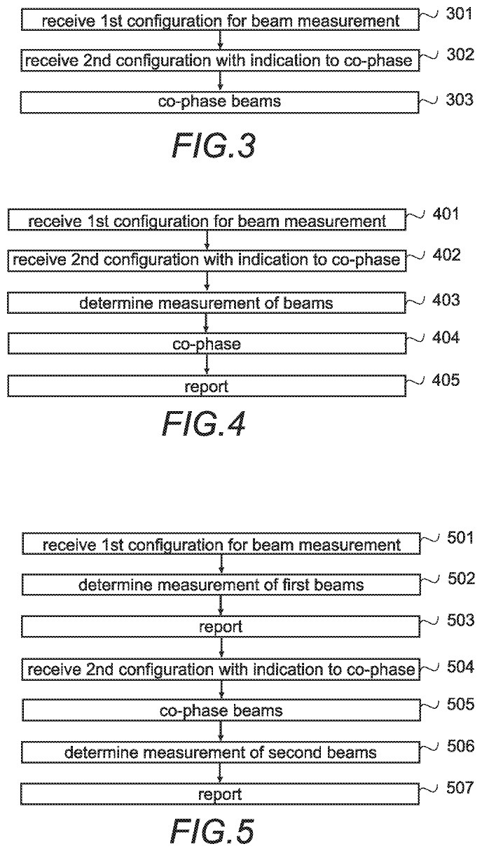

FIG. 3 illustrates an example functionality of the first apparatus. Referring to FIG. 3, the first apparatus receives in block 301, from a second apparatus controlling an operation of a serving cell, first configuration information for beam measurements for a set of first beams. In the illustrated example of FIG. 3, the first apparatus receives in block 302 from the second apparatus second configuration information with an indication to co-phase two or more first beams to one or more second beams. Depending on an implementation, the first configuration information and the second configuration information may be received in one message, or in separate messages, that may be consecutive messages or there may be some time between the messages.

The first apparatus then co-phases in block 303, per a second beam, corresponding two or more first beams to the second beam.

The co-phasing may be performed by summing the two or more first beams, for example adjacent first beams. For example, the summation may be performed on the signals received from the CSI-RS or SSB resources configured in the same resource group of a resource group set configuring the second beams. For example, the signals received on one port per a resource in a resource group are added together such that the number of ports after co-phasing is the same as the number of ports per the resource in the resource set The summation may be done between ports of the same index or of different indices for different resources.

The co-phasing may also be performed by applying a phase rotation to one or more of the CSI-RS or SSB resources in a resource group associated to a second beam before summation. These phase rotations may be the same or different for different port indices of the same resource and the summation may be performed between ports of the same index or of different indices for different resources. These phase rotations may be indicated by the second apparatus to the first apparatus by means of a codebook where a codebook component contains information of the phase rotations and, if applicable, the associated port indices to combine the CSI-RS or SSB resources in a resource group to form a second beam. The codebook may also contain information needed to associate resources in resource groups, if this information is not provided in the CSI-RS or SSB resource set configuration. Different codebooks may be indicated for different resource group sets.

Further, the co-phasing may be performed by applying a corresponding co-phasing codebook. For example, the first apparatus may be preconfigured with a set of codebooks, and the second configuration may indicate the codebook to use, or the first apparatus may receive information which codebook to use via radio resource control, or via medium access control control element, or via downlink control information. Still a further possibility includes a codebook tailored for the first apparatus, the codebook being downloadable to the first apparatus from a cloud and accessible by the second apparatus to modify the codebook.

It should be appreciated that the above are non-limiting examples of how to perform the co-phasing, and any other suitable ways or means may be used as well.

In an example, the first apparatus receives, according to the first configuration, a set of 16 beams, i=0, . . . 15, with P ports. P is a positive integer whose value may be 1, 2, etc. The first beam i is Hᵢ=[h_{i,0}, . . . , h_{i,P-1}]. Then the first apparatus receives the second configuration information with indication to co-phase the set to 4 second beams j=0, . . . ,3, by applying a corresponding co-phasing codebook element wⱼ=[w_{j,0}, . . . , W_{j,P-1}] to form a new synthesized P-port beam, Hⱼ^{eq}=[h_{j,0}^{eq}, . . . , h_{j,P-1}^{eq}] as follows

h_{j,p}^{eq}=Σᵢ₌₄ₚ^{4p+3}w_{j,p}h_{i,p},for j=0, . . . ,3, p=0, . . . , P−1

Note that the 4 co-phased beams Hⱼ^{eq} have the same number of ports as the transmitted beams Hᵢ.

Even though not illustrated in FIG. 3, it is possible that the first apparatus determines a measurement or measurements of the first beams according to the first configuration received in block 301. The first apparatus may measure first beams accordingly and/or may cause one or more other entities to measure the first beams. For example, the first apparatus and/or the entities/entity may measure downlink beam reference signals, for example synchronization signal blocks or tracking reference signals or channel state information reference signals.

FIG. 4 illustrates another example functionality of the first apparatus. Referring to FIG. 4, the first apparatus receives in block 401, from a second apparatus controlling an operation of a serving cell, first configuration information for beam measurements for a set of first beams. Further, in the illustrated example of FIG. 3, the first apparatus receives in block 402 from the second apparatus second configuration information with an indication to co-phase two or more first beams to one or more second beams. Depending on an implementation, the first configuration information and the second configuration information may be received in one message, or in separate messages, that may be consecutive messages.

The first apparatus determines in block 403 a measurement or measurements of the first beams and a measurement or measurements of the second beams. The measurement(s) of the first beams are determined according to the first configuration information. The measurement(s) of the second beams are determined according to the first configuration information and/or the second configuration information, depending on the content of the configuration information, for example. The determining of the measurement(s) may include the first apparatus to perform the measurements and/or to obtain the measurement results by causing one or more other entities to perform the measurements. The measurements may include measuring receive power of beam reference signals, for example synchronization signal blocks or tracking reference signals or channel state information reference signals, of corresponding beams.

The first apparatus also co-phases in block 404, per a second beam, corresponding two or more first beams to the second beam, as described above. It should be appreciated that blocks 403 and 404 may be performed in parallel or in another order than described herein.

In the illustrated example of FIG. 4, the first apparatus reports in block 405 one or more beams determined to be best beam(s) based on measurement results of the first beams and the second beams. For example, the first apparatus may report a best beam, be that a first beam or a second beam, the best beam having, for example highest receive power, with or without a corresponding reference signal received power, RSRP. In a similar way, the first apparatus may report N best beams. A further alternative include that the first apparatus may report the best first beam with or without corresponding RSRP and the best second beam (with or without corresponding RSRP. The first apparatus may also report two or more best first beams with or without corresponding RSRP and two or more best second beams with or without corresponding RSRP. It should be appreciated that the number of reported first beams may be equal to or different from the number of reported second beams. The best beam(s) may be indicated by a corresponding index value/values, such as CRI or SSBRI. An index value is mapped to a corresponding resource, or a resource group in the configured set of resources.

FIG. 5 illustrates another example functionality of the first apparatus. Referring to FIG. 5, the first apparatus receives in block 501, from a second apparatus controlling an operation of a serving cell, first configuration information for beam measurements for a set of first beams. The first apparatus then determines in block 502 a measurement or measurements of the first beams according to the first configuration information. The determining of the measurement(s) may include the first apparatus to perform the measurements and/or to obtain the measurement results by causing one or more other entities to perform the measurements of the first beams, for example as described above with FIG. 4.

The first apparatus reports in block 503 one or more first beams determined to be best beam(s) based on measurement results of the first beams. For example, the first apparatus may report a best first beam having, for example highest receive power, with or without a corresponding reference signal received power, RSRP. In a similar way, the first apparatus may report N best first beams. The best first beam(s) may be indicated by a corresponding index value/values, such as CRI or SSBRI. An index value is mapped to a corresponding resource in the configured set of resources.

In the illustrated example of FIG. 5, the first apparatus receives in block 504 from the second apparatus second configuration information with an indication to co-phase two or more first beams to one or more second beams. Depending on an implementation, the first configuration information and the second configuration information may be received in one message, or in separate messages, that may be consecutive messages or there may be some time between the messages.

The first apparatus co-phases in block 505, per a second beam, corresponding two or more first beams to the second beam, as described above.

The first apparatus also determines in block 506 a measurement or measurements of the second beams. The measurement(s) of the second beams may be determined according to the second configuration information and/or the first configuration information, depending on the content of the configuration information, for example. The determining of the measurement(s) may include the first apparatus to perform the measurements and/or to obtain the measurement results by causing one or more other entities to perform the measurements of the second beams, for example as described above with FIG. 4.

It should be appreciated that blocks 505 and 506 may be performed in parallel or in another order than described herein.

The first apparatus reports in block 507 one or more second beams determined to be best beam(s) based on measurement results of the second beams. For example, the first apparatus may report a best second beam having, for example highest receive power, with or without a corresponding reference signal received power, RSRP. In a similar way, the first apparatus may report N best second beams. The best second beam(s) may be indicated by a corresponding index value/values, such as CRI or SSBRI. An index value is mapped to a corresponding resource group in the configured set of resources.

It should be appreciated that the number of first beams reported in block 503 may be equal to or different from the number of second beams reported in block 507.

Further, it should be appreciated that the first apparatus may report (blocks 503, 507) the best first beam(s) and the best second beam(s) in parallel.

FIG. 6 illustrates an example functionality of the second apparatus. Referring to FIG. 6, the second apparatus is controlling (block 601) the operation of a cell serving the first apparatus. The second apparatus transmits in block 602 to the first apparatus first configuration information for beam measurements for a set of first beams and in block 603 to the first apparatus second configuration information with an indication to co-phase two or more first beams to one or more second beams. The second apparatus may indicate a codebook to use, as described above, and/or modify the codebook in the cloud. Depending on an implementation, the first configuration information and the second configuration information may be transmitted in one message, or in separate messages, that may be consecutive messages or there may be some time between the messages.

FIG. 7 illustrates another example functionality of the second apparatus. Referring to FIG. 7, the second apparatus is controlling (block 701) the operation of a cell serving the first apparatus. The second apparatus transmits in block 702 to the first apparatus first configuration information for beam measurements for a set of first beams. When the second apparatus determines in block 703 that a mobility state of the first apparatus is a high mobility state, the second apparatus transmits in block 704 to the first apparatus second configuration information with an indication to co-phase two or more first beams to one or more second beams. The second apparatus may indicate a codebook to use, as described above, and/or modify the codebook in the cloud.

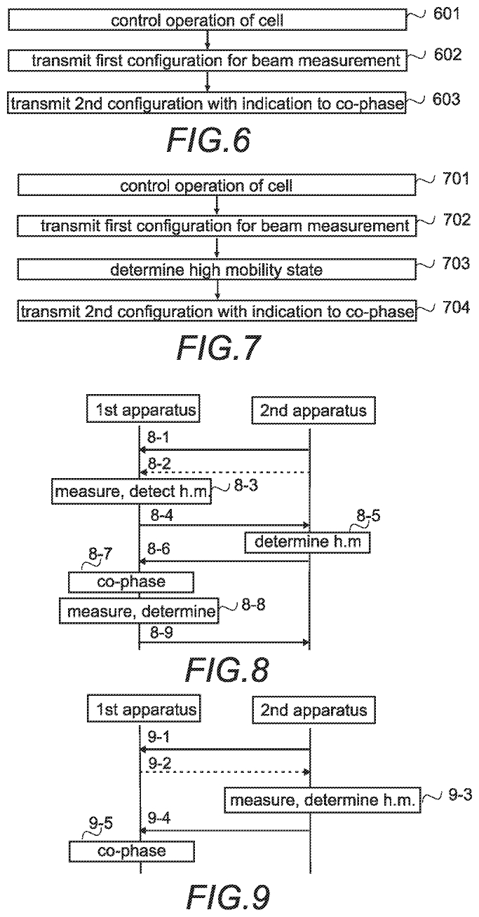

FIGS. 8 and 9 illustrate non-limiting examples of information exchange between the first apparatus and the second apparatus, which is controlling a cell serving the first apparatus. It should be appreciated that other information, for example reporting measurement results and/or data traffic related information exchange, may take place but they are not discussed/disclosed in detail herein for the sake of clarity of the description. Further, in the illustrated examples of FIGS. 8 and 9 it is assumed, for the clarity of description, that an apparatus configured to determine measurements of the beams, measure the beams correspondingly, the expression covering in the examples also that the apparatus may cause one or more other entities to perform the measurements, alternatively or in addition to the apparatus. In other words, the disclosed principles may be applied regardless which entity or entities, including the first and/or second apparatus, perform the actual measurements.

Referring to FIG. 8, the first apparatus receives (message 8-1) from the second apparatus the first configuration for beam measurements for a set of first beams. In the illustrated example, the first apparatus receives in the first configuration information, a mobility detection configuration. The mobility detection configuration comprises a criterion for detecting a high mobility state of the first apparatus. The criterion may relate to channel estimation variation or timing offset variation or Doppler frequency estimation, for example.

The second apparatus also transmits (message 8-2) over said set of first beams reference signals, for example synchronization signal blocks or tracking reference signals.

The first apparatus determines measurements of first beams according to the first configuration information and measures (block 8-3) the first beams, and in the illustrated example detects in block 8-3, that the criterion in the mobility detection configuration is satisfied and the state of the first apparatus is a high mobility state (h.m.). The first apparatus sends, in response to the criterion being satisfied, to the second apparatus an indication (message 8-4) of the high mobility state.

The second apparatus determines in block 8-5 the high mobility state of the first apparatus responsive to receiving from the first apparatus the indication (message 8-4) of the high mobility state, and hence transmits (message 8-6) to the first apparatus the second configuration information with an indication to co-phase two or more first beams to one or more second beams. Different examples of the indication are given above. In an implementation, the second apparatus may also access and modify a codebook in a cloud.

The first apparatus then, responsive to message 8-6, co-phases in block 8-7, per a second beam, corresponding two or more first beams to the second beam, as described above.

In the illustrated example the first apparatus is configured to determine measurements of the beam reference signals (messages 8-2 are transmitted periodically) and to measure in block 8-8 both the first beams and the second beams. The first beams within a second beam may be received by the same receive filter in the first apparatus. The way how to measure the second beams, for example reference signal reception power or signal to interference noise ration may be provided in a higher layer configuration, for example by the second apparatus providing a codebook where a codebook element consists of co-phasing coefficients applicable to a second beam, or it may be determined by first apparatus implementation. In the illustrated example, the first apparatus is further configured to determine in block 8-8, based on measurement result, the best beam, be that a first beam or a second beam, and report (message 8-9) the best beam to the second apparatus, for example by sending an index value of the best beam. In another example, the first apparatus may be configured to report one or more group index values that are candidate second beams within the set of first beams. The first apparatus may also be configured to report measurement results per a reported index value. It should be appreciated that instead of using index values, an indication of whether a measurement result reported is obtained over a first beam or over a second beam, may be used as well.

Referring to FIG. 9, the first apparatus receives (message 9-1) from the second apparatus the first configuration for beam measurements for a set of first beams. In the illustrated example, the first apparatus may or may not receive in the first configuration information, a mobility detection configuration.

The first apparatus transmits (message 9-2) over said set of first beams sounding reference signals or demodulation reference signals.

The second apparatus determines measurements of the reference signals to determine mobility state of the first apparatus and measures (block 9-3) the signals correspondingly. In the illustrated example the second apparatus detects in block 9-3, that a criterion for detecting a high mobility state is satisfied and the state of the first apparatus is a high mobility state (h.m). The second apparatus then transmits (message 9-4) to the first apparatus the second configuration information with an indication to co-phase two or more first beams to one or more second beams. Different examples of the indication are given above. In an implementation, the second apparatus may also access and modify a codebook in a cloud.

The first apparatus then, responsive to message 9-4, co-phases in block 9-5, per a second beam, corresponding two or more first beams to the second beam, as described above. Then the first apparatus may determine measurements and measure, or cause measurements, and report the first beams and/or the second beams as described above with FIG. 8, even though not illustrated in FIG. 9.

In a further example, both the first apparatus and the second apparatus may determine measurements of reference signals and cause measurements of the reference signals and/or perform the measurements to determine the mobility state of the first apparatus, and the first apparatus may detect the high mobility state when the indication of co-phase is received.

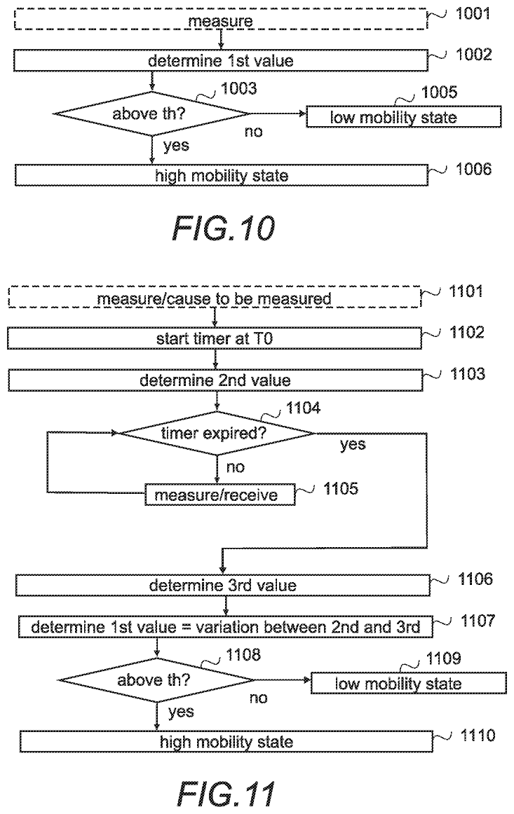

FIGS. 10 and 11 illustrate example functionalities how the first apparatus and/or the second apparatus may determine a mobility state of the first apparatus based on beam measurements, for example based on reference signal measurement results. In the illustrated example of FIG. 10, a mobility threshold is used for determining a mobility state, and in the illustrated example of FIG. 11, the mobility threshold and a timer, called for example a mobility detection timer, are used for determining the mobility state. When the first apparatus performs the process of FIG. 10, it may receive the mobility threshold as a criterion in a mobility detection configuration in the first configuration. Correspondingly, it may receive the mobility threshold as a criterion and the mobility detection timer in a mobility detection configuration in the first configuration.

Referring to FIG. 10, using measurement result obtained by measuring (block 1001) first beams by the apparatus and/or by another entity, a first value is determined in block 1002. The first value may relate to channel estimation or timing offset or Doppler frequency estimation. If the first value is not above a mobility threshold, th, (block 1003: no), the mobility state is a low mobility state (block 1005). If the first value is above the mobility threshold, i.e. the criterion is satisfied, (block 1003: yes), the mobility state is a high mobility state.

Referring to FIG. 11, first beams are measured (block 1101) and/or caused to be measured by another entity and then the mobility detection timer is started in block 1102 at time TO. A second value is determined in block 1002 using measurement results of first beams available at the time TO, i.e. at the starting time of the mobility detection timer. The second value may relate to channel estimation or timing offset. Measuring (block 1105), and/or receiving measurement results of, first beams is continued (block 1104: no). When the mobility detection time expires (block 1104: yes) at time TE, a third value is determined in block 1106 based on measurement results of the first beams available at the time TE. The third value may relate to channel estimation or timing offset, in a similar way as the second value, the difference between the values being the time the values are determined, and hence different measurement results used in determining the values.

The first value is determined in block 1107 by determining a variation between the second value and the third value. For example, the second value may be deducted from the first value.

If the first value is not above a mobility threshold, th, (block 1108: no), the mobility state is a low mobility state (block 1109). If the first value is above the mobility threshold, i.e. a criterion is satisfied, (block 1110: yes), the mobility state is a high mobility state.

Even though in the above examples in which a criterion is used, the mobility state, i.e. high mobility or not high mobility, is used as the criterion to determine when to transmit the second configuration with the indication of co-phase beams, also another criterion that indicates when it is better to use a wider beam may be used as well. For example, measured receive powers may be used as a criterion to determine when to transmit the second configuration and/or when to use a wider beam.

It should be appreciated that even though in the above examples it is assumed that two configurations are used, more than two configurations may be used. As a non-limiting example, for a set with 64 beams, the second apparatus may configure 3 Resource Group Sets: a Resource Group Set 0 with group size 1, which may correspond to the first configuration information with 64 index values, one index value associated to one beam (a first beam); a Resource Group Set 1 with group size 4, where there are 16 possible groups of 4 beams, i.e. 16 possible second beams, a second beam having 4 first beams, wherein one group index value is associated to a group of 4 first beams; and a Resource Group Set 2 with group size 8 where there are 8 possible groups of 8 beams, i.e. 8 possible second beams, a second beam having 8 first beams, wherein one group index value is associated to a group of 8 first beams. The first apparatus may be configured to report a single group index from one of the group sets {0,1,2} or a subset of group sets, for example {0,1} for non high-mobility state and {1,2} for high mobility state.

As can be seen from the above examples, P1 procedure for beam reporting, i.e. the procedure in which the second apparatus performs a beam sweep over an entire cell and the first apparatus measures a power of received signals, for example, from all beams received, and reports to the second apparatus the beam that has the highest received power, is extended by introducing the co-phased second beams. The second beams can be used also when the first apparatus is configured for a further beam refinement operation, or a channel state information reporting with a precoding matrix indicator. The above examples also extend use of codebook-based reporting to be used for beam reporting.

The disclosed examples make it possible for the second apparatus to allow wider beams for first apparatuses that are moving with a high speed (are in a high mobility state) whereas first apparatuses that are stationary or moving with a lower speed can benefit from the narrower beams. Further, the change in the movement speed may be taken into account to provide a first apparatus with beam width corresponding to the movement speed.

The blocks, related functions, and information exchanges described above by means of FIGS. 2 to 11 are in no absolute chronological order, and some of them may be performed simultaneously or in an order differing from the given one, or repeated even though repetition is not illustrated. For example, reporting may be repeated several times per a configuration information received. Other functions can also be executed between them or within them, and other information may be transmitted. Some of the blocks or part of the blocks or one or more pieces of information can also be left out or replaced by a corresponding block or part of the block or one or more pieces of information. Further, the different implementations described for a block may be freely combined with any of different implementations of another block.

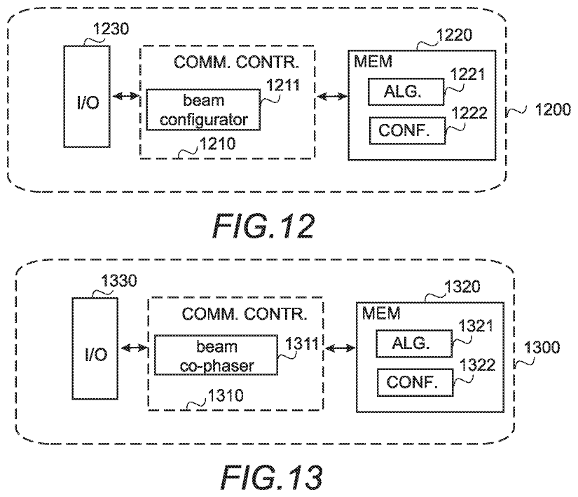

FIGS. 12 and 13 illustrate apparatuses comprising a communication controller 1210, 1310 such as at least one processor or processing circuitry, and at least one memory 1220, 1320 including a computer program code (software, algorithm) ALG. 1221, 1321, wherein the at least one memory and the computer program code (software, algorithm) are configured, with the at least one processor, to cause the respective apparatus to carry out any one of the embodiments, examples and implementations described above. FIG. 12 illustrates a second apparatus, for example a base station or an access node or a transmission-reception point, configured at least to configure first apparatuses (devices) to co-phase beams or corresponding resources. FIG. 13 illustrates a first apparatus, such as a user equipment, or terminal device in a vehicle, or any entity served by a wireless access network, to co-phase beams or corresponding resources as configured by the apparatus of FIG. 12. The apparatuses of FIGS. 12 and 13 may be electronic devices, examples being listed above with FIGS. 1 and 2.

Referring to FIGS. 12 and 13, the memory 1220, 1320 may be implemented using any suitable data storage technology, such as semiconductor based memory devices, flash memory, magnetic memory devices and systems, optical memory devices and systems, fixed memory and removable memory. The memory may comprise a configuration storage CONF. 1221, 1321, such as a configuration database, for example for beam related configurations, for example index values and/or associations associating, per a second beam, first beams co-phased to the second beam with the second beam. The memory 1220, 1320 may further store other data, for example codebooks, or access information to codebooks.

Referring to FIG. 12, the apparatus comprises a communication interface 1230 comprising hardware and/or software for realizing communication connectivity according to one or more wireless and/or wired communication protocols. The communication interface 1230 may provide the apparatus with radio communication capabilities with different apparatuses, for example with the apparatus of FIG. 13, as well as communication capabilities towards the core network.

Digital signal processing regarding transmission and reception of signals may be performed in a communication controller 1210. The communication interface may comprise standard well-known components such as an amplifier, filter, frequency-converter, (de) modulator, and encoder/decoder circuitries and plurality of antennas.

The communication controller 1210 comprises a beam configuring circuitry 1211 (beam configurator) configured to provide first apparatuses with configuration information according to any one of the embodiments/examples/implementations described above. The communication controller 1210 may control the beam configuring circuitry 1211.

In an embodiment, at least some of the functionalities of the apparatus of FIG. 12 may be shared between two physically separate apparatuses, forming one operational entity. Therefore, the apparatus may be seen to depict the operational entity comprising one or more physically separate apparatuses for executing at least some of the processes described with a second apparatus.

Referring to FIG. 13, the apparatus 1300 may further comprise a communication interface 1330 comprising hardware and/or software for realizing communication connectivity according to one or more wireless communication protocols. The communication interface 1330 may provide the apparatus 1300 with communication capabilities with the apparatus of FIG. 12, for example. The communication interface may comprise standard well-known analog components such as an amplifier, filter, frequency-converter and circuitries, conversion circuitries transforming signals between analog and digital domains, and one or more antennas. Digital signal processing regarding transmission and reception of signals may be performed in a communication controller 1310.

The communication controller 1310 comprises a beam co-phasing circuitry 1311 (beam co-phaser) configured to measure beams, co-phase beams, and/or report measurement results according to any one of the embodiments/examples/implementations described above. The communication controller 1310 may control the beam co-phasing circuitry 1311.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 2 to 11 may be carried out by an apparatus comprising corresponding means for carrying out at least some of the described processes. The apparatus may comprise separate means for separate phases of a process, or means may perform several phases or the whole process. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments/examples/implementations described herein.

According to yet another embodiment, the apparatus carrying out the embodiments/examples comprises a circuitry including at least one processor and at least one memory including computer program code. When activated, the circuitry causes the apparatus to perform at least some of the functionalities according to any one of the embodiments/examples/implementations of FIGS. 2 to 11, or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the apparatuses described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments/examples/implementations as described may also be carried out in the form of a computer process defined by a computer program or portions thereof. Embodiments of the methods described in connection with FIGS. 2 to 11 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. A first apparatus comprising
at least one processor; and
at least one memory including computer program code, the at least one memory and computer program code being configured to, with the at least one processor, cause the first apparatus to perform:
receiving, from a second apparatus controlling an operation of a serving cell, first configuration information for beam measurements for a set of first beams;
receiving, from the second apparatus, second configuration information with an indication to co-phase two or more first beams to one or more second beams; and
co-phasing, per a second beam, corresponding two or more first beams to the second beam.

2. The first apparatus of claim 1, wherein the first beams and the one or more second beams are P port beams, wherein P is a positive integer.

3. The first apparatus of claim 1, wherein the at least one memory and computer program code are configured to, with the at least one processor, further cause the first apparatus to perform, per the second beam, the co-phasing by summing the two or more first beams or by applying a corresponding co-phasing codebook.

4. The first apparatus of claim 1, wherein the at least one memory and computer program code are configured to, with the at least one processor, further cause the first apparatus to perform:
receiving, from the second apparatus, in the first configuration information, a mobility detection configuration, the mobility detection configuration comprising a criterion for detecting a high mobility state of the first apparatus;
determining a measurement of the first beams according to the first configuration information;
sending, in response to the criterion being satisfied, to the second apparatus an indication of the high mobility state; and
receiving the second configuration information as a response to the indication.

5. The first apparatus of claim 4, wherein the mobility detection configuration comprises at least a mobility threshold as the criterion, and wherein the at least one memory and computer program code are configured to, with the at least one processor, further cause the first apparatus to perform:
determining, based at least on beam measurement results of the first beams, a first value; and
determining that the criterion is satisfied at least when the first value exceeds the mobility threshold.

6. The first apparatus of claim 5, wherein the mobility detection configuration further comprises a mobility detection timer, and wherein the at least one memory and computer program code are configured to, with the at least one processor, further cause the first apparatus to perform:
starting the mobility detection timer;
determining, at a starting time of the mobility detection timer, a second value based on corresponding measurement results of the first beams;
determining, at a time the mobility detection timer expires, a third value based on corresponding measurement results of the first beams; and
determining the first value by determining a variation between the second value and the third value.

7. The first apparatus of claim 5, wherein the first value is a channel estimation variation, or a timing offset variation or a Doppler frequency estimation.

8. The first apparatus of claim 1, wherein a first beam is associated to a channel state information reference signal resource or to a synchronization signal block resource of a resource set and the second beam is associated with a group of channel state information reference signal resources or to a group of synchronization signal block resources within the resource set.

9. The first apparatus of claim 1, wherein the at least one memory and computer program code are configured to, with the at least one processor, further cause the first apparatus to perform:
determining measurements of both the first beams and the second beams;
determining a best beam amongst the first beams and the second beams; and
reporting to the second apparatus the best beam by indicating a beam index of the best beam.

10. A second apparatus comprising
at least one processor; and
at least one memory including computer program code, the at least one memory and computer program code being configured to, with the at least one processor, cause the second apparatus to perform:
controlling the operation of a cell serving a first apparatus;
transmitting, to the first apparatus, first configuration information for beam measurements for a set of first beams; and
transmitting to the first apparatus second configuration information with an indication to co-phase two or more first beams to one or more second beams.

11. The second apparatus of claim 10, wherein the at least one memory and computer program code are configured to, with the at least one processor, further cause the second apparatus to:
determining a high mobility state of the first apparatus responsive to receiving from the first apparatus an indication of the high mobility state; and
transmitting the second configuration information in response to the high mobility state.

12. The second apparatus of claim 10, wherein the at least one memory and computer program code are configured to, with the at least one processor, further cause the second apparatus to:
determining a measurement of reference signals transmitted by the first apparatus;
determining, based at least on measurement results, a first value;
determining a high mobility state of the first apparatus responsive to the first value exceeding a mobility threshold; and
transmitting the second configuration information in response to the high mobility state.

13. The second apparatus of claim 12, wherein the at least one memory and computer program code are configured to, with the at least one processor, further cause the second apparatus to perform:
starting a mobility detection timer;
determining, at a starting time of the mobility detection timer, a second value based on corresponding measurement results of the reference signals;
determining, at a time the mobility detection timer expires, a third value based on corresponding measurement results of the reference signals; and
determining the first value by determining a variation between the second value and the third value.

14. The second apparatus of claim 12, wherein the first value is a channel estimation variation, or a timing offset variation or a Doppler frequency estimation.

15. A method comprising:
receiving, by a first apparatus, from a second apparatus controlling an operation of a serving cell, first configuration information for beam measurements for a set of first beams;
receiving, by the first apparatus, from the second apparatus, second configuration information with an indication to co-phase two or more first beams to one or more second beams; and
co-phasing, per a second beam, corresponding two or more first beams to the second beam.

16. A method comprising:
controlling, by a second apparatus, the operation of a cell serving a first apparatus;
transmitting, by the second apparatus, to the first apparatus, first configuration information for beam measurements for a set of first beams; and
transmitting, by the second apparatus, to the first apparatus, second configuration information with an indication to co-phase two or more first beams to one or more second beams.

17. The method of claim 15, wherein the first beams and the one or more second beams are P port beams, wherein P is a positive integer.

18. The method of claim 15, wherein the co-phasing, per the second beam, is by summing the two or more first beams or by applying a corresponding co-phasing codebook.

19. The method of claim 15, further comprising:
receiving, from the second apparatus, in the first configuration information, a mobility detection configuration, the mobility detection configuration comprising a criterion for detecting a high mobility state of the first apparatus;
determining a measurement of the first beams according to the first configuration information;
sending, in response to the criterion being satisfied, to the second apparatus an indication of the high mobility state; and
receiving the second configuration information as a response to the indication.

20. The method of claim 19, wherein the mobility detection configuration comprises at least a mobility threshold as the criterion, and wherein the method further comprises:
determining, based at least on beam measurement results of the first beams, a first value; and
determining that the criterion is satisfied at least when the first value exceeds the mobility threshold.
